(19) United States
(12) Patent Application Publication
(10) Pub. No.: US 2024/0124329 A1
(43) Pub. Date: Apr. 18, 2024

(54) MATERIALS AND METHODS FOR EXTRACTION OF PRECIOUS METALS USING GRAPHENE OXIDE COMPOSITES

(71) Applicant: G6 Materials Corp., Ronkonkoma, NY (US)

(72) Inventors: Daniel Stolyarov, Middle Island, NY (US); Elena Polyakova, Middle Island, NY (US); Valentyna Voskresenska, Miller Place, NY (US); Anastocios Arima, Sunny Isles Beach, FL (US); Patrick Brindle, Oakdale, PA (US)

(73) Assignee: G6 Materials Corp., Ronkonkoma, NY (US)

(21) Appl. No.: 18/464,217

(22) Filed: Sep. 9, 2023

Related U.S. Application Data
(60) Provisional application No. 63/375,122, filed on Sep. 9, 2022.

(51) Int. Cl. C02F 1/28; B01J 20/20; B01J 20/28; C22B 3/24; C22B 11/00

(52) U.S. Cl. CPC C02F 1/283; B01J 20/205; B01J 20/28033; C22B 3/24; C22B 11/04; C02F 2101/20

(57) ABSTRACT

A system for extraction of metal out from a liquid solution. The system may include a housing and a filter. The housing may have an inlet and an outlet. The filter may be carried by the housing, and the filter may include a sorption media that may comprise a graphene oxide material. The filter may be in fluid communication with the inlet and the outlet of the housing. The liquid solution may comprise a liquid solution that contains at least one metal. The housing may be shaped as a cartridge. The inlet may be configured to be removably engaged in fluid communication with an external apparatus that may provide a source of the liquid solution.

### RELATED APPLICATIONS

This application claims priority under 35 U.S.C. § 119(e) of U.S. Provisional Patent Application Ser. No. 63/375,122 (Attorney Docket No. 4460.00026) filed on Sep. 9, 2022, and titled Materials and Methods for Extraction of Precious Metals Using Graphene Oxide Composites. The content of this application is incorporated herein by reference except for the content therein conflicts with the content herein.

### FIELD OF THE INVENTION

The present invention relates to systems and methods for extraction of elements including metals, alloys, ingots, ores, deposits, and the like using a filter.

### BACKGROUND OF THE INVENTION

Conventionally, there is a combination of technologies and methods used in the mining facilities in order to extract the desired metals from the mined minerals. The ore and associated waste rock first crushed and ground to the size be exposed efficiently exposed to an efficient leaching process. As the result a liquid containing a certain concentration of a desired metals in forms of ions, dissolved salts and chemical complexes is formed.

In the case gold mining, one of the common leaching processes is gold cyanidation or MacArthur-Forrest process is used. In this process the ground ore further concentrated by means of froth flotation or centrifugation is mixed with water to produce a slurry or pulp. The slurry is further mixed with sodium, potassium, or calcium cyanide. The gold present in the ore then undergoes a chemical reaction (in the case of sodium cyanide:

4Au+8NaCN+O2+2H2O→4Na[Au(CN)2]+4NaOH

As the result a water-soluble coordination compound is formed.

One of the conventionally used methods to extract the solubilized gold from solution is by exposure such solution to activated carbon in the process commonly referred as Carbon-in-pulp (“CIP”), where the leached pulp mixed with activated carbon is into a series of tanks in the counterflow arrangement.—In the final tank a solution containing gold in low concentration generally referred as tailings solution is formed, the typical concentration of gold in the tailings solution is 1.8 mg/kg.

In the alternative method generally referred as carbon-in-leach (“CIL”), the carbon is mixed with a leach solution and not with slurry. In the process generally referred to as carbon-in-column (“CIC”) the activated carbon is mixed with ground ore and loaded into a column and the leaching solution is passing through. The gold is conventionally further recovered from the impregnated activated carbon by the process generally referred as electrowinning. The capacity of activated carbon to adsorb gold is generally having value of 50-60 mg/kg.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a system for extraction of metal out from a liquid solution. The system may include a housing and a filter. The housing may have an inlet and an outlet. The filter may be carried by the housing, and the filter may include a sorption media that may comprise a graphene oxide material. The filter may be in fluid communication with the inlet and the outlet of the housing. The liquid solution may comprise a liquid solution that contains at least one metal. The housing may be shaped as a cartridge. The inlet may be configured to be removably engaged in fluid communication with an external apparatus that may provide a source of the liquid solution.

The graphene oxide material may include one or more of graphene oxide, functionalized graphene oxide, reduced graphene oxide, and activated carbon impregnated with graphene oxide or with reduced graphene oxide. The graphene oxide material may comprise a water insoluble hydrogel that may include graphene oxide associated with at least one polymer. The at least one polymer may comprise one or more of hyaluronic acid, chitosan, heparin, alginate, fibrin, polyvinyl alcohol, polyethylene glycol, sodium polyacrylate, and acrylate polymer/copolymer.

The graphene oxide material may be in combination with one or more of activated carbon, zeolite, aluminosilicate, natural clay, synthetic clay, natural fiber, and synthetic fiber. The filter may comprise a membrane, fiber, felt, and/or a plurality of pellets. The system may further include a vent pipe that may be in fluid communication with the housing. The filter may be arranged to be in a dead-end filter arrangement and/or a pass-over filter arrangement. The at least one metal that may be contained by the liquid solution may comprise one or more of a metal alloy, metal ingot, metal ore, metal ion, cationic metal ion, metal salts, chemical complex of metal, gold, platinum, rare earth metal, and radioactive metal.

A method aspect of the present invention may be directed to a method for extraction of metal out from a liquid solution using a system that may include a housing and a filter. The housing may have an inlet and an outlet. The filter may be carried by the housing, and the filter may include a sorption media that may comprise a graphene oxide material. The filter may be in fluid communication with the inlet and the outlet of the housing. The liquid solution may comprise a liquid solution that contains at least one metal. The housing may be shaped as a cartridge. The inlet may be configured to be removably engaged in fluid communication with an external apparatus that may provide a source of the liquid solution.

The method may include connecting the inlet to be in communication with a source of the liquid solution, and may further include pumping the liquid solution into the inlet. The method may yet further include adsorbing the at least one metal of the liquid solution with the sorption media to define metal enriched sorption media. The method may also include extracting the metal from the metal enriched sorption media.

The step of extracting the metal from the metal enriched sorption media may comprise centrifugation, ultracentrifugation, filtration, ultra-filtration, precipitation, electrophoresis, reverse osmosis, sedimentation, incubation, treatment with acids, treatment with bases, treatment with chelating agents, and/or magnetic separation. The method may further include disconnecting the inlet from the source of the liquid solution. The method may yet further include replacing the metal enriched sorption media with an unenriched sorption media.

The graphene oxide material may include one or more of graphene oxide, functionalized graphene oxide, reduced graphene oxide, and activated carbon impregnated with graphene oxide or with reduced graphene oxide. The graphene oxide material may comprise a water insoluble hydrogel that may include graphene oxide associated with at least one polymer. The at least one polymer may comprise one or more of hyaluronic acid, chitosan, heparin, alginate, fibrin, polyvinyl alcohol, polyethylene glycol, sodium polyacrylate, and acrylate polymer/copolymer.

The graphene oxide material may be in combination with one or more of activated carbon, zeolite, aluminosilicate, natural clay, synthetic clay, natural fiber, and synthetic fiber. The filter may comprise a membrane, fiber, felt, and/or a plurality of pellets. The system may further include a vent pipe that may be in fluid communication with the housing. The filter may be arranged to be in a dead-end filter arrangement and/or a pass-over filter arrangement. The at least one metal that may be contained by the liquid solution may comprise one or more of a metal alloy, metal ingot, metal ore, metal ion, cationic metal ion, metal salts, chemical complex of metal, gold, platinum, rare earth metal, and radioactive metal.

### BRIEF DESCRIPTION OF THE DRAWINGS

Some embodiments of the present invention are illustrated as an example and are not limited by the figures of the accompanying drawings, in which like references may indicate similar elements.

FIG. 1 is a schematic diagram illustratively showing a filter according to an embodiment of the present invention.

FIG. 2 is a schematic diagram illustratively showing a pellet filter cartridge according to an embodiment of the present invention.

FIG. 3 is a schematic diagram illustratively showing a membrane filter cartridge according to an embodiment of the present invention.

FIG. 4 is a schematic diagram illustratively showing sorption media according to embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

The present invention is generally referred to the materials and method to be used for the recovery of gold from the low-grade tailing's solution.

These materials and methods reach leached gold containing solution in place for the activated in the CIP, CIL or CIC processes.

Accordingly, the present invention may be directed to materials based on the graphene oxide and reduced graphene oxide to be used as a sorption media for extraction of gold and other metals out of liquid solution. The materials may include graphene oxide associated with polymers to form water insoluble hydrogel, as well as activated carbon impregnated with graphene oxide or reduced graphene oxide. Articles may be formed out of the sorption media to be further used for fabrication of the filter cartridge. The articles may include Pellets fabricated by extrusion, compression, etc. . . . . The articles may also include membranes and fibers that further can be converted into yarns, felts, and textiles. The present invention is also directed to an apparatus that facilitates the extraction of metals in an industrial arrangement.

### Materials

In the present invention graphene oxide is proposed to be used for sorption of the gold out of the gold-containing solution.

Graphene oxide (“GO”) is a compound of carbon, oxygen, and hydrogen in variable ratios, obtained by treating graphite with strong oxidizers and acids. Graphene oxide is a two-dimensional material formed by a carbon lattice decorated with functional groups such as epoxy, carbonyl, hydroxyl, and could be functionalized with other chemical groups if necessary. Graphene oxide can be further processed by a chemical agent or an annealing at elevated temperatures for removal of the functional groups and forming a reduced graphene oxide (“rGO”). Due to their two-dimensional nature, these materials have large specific surface area with a theoretical limit of 2,640 m2/g and in practice in the range of 800-900 m2/g.

Graphene oxide has outstanding ability to absorb the gold and other metals from the solution. Due to its planar nature and exposed surface, and presence of the functional groups graphene oxide can provide for rapid and efficient absorption of the cationic metal ions such as Pb(II), Cd(II), As(III), As(V), Cr(IV) etc. as indicated in the publication by Y. Cao and X. Li [8].

In one of the embodiments of the present invention, the graphene oxide is used for adsorption of gold by the process described in the patent by J. M. Toure et al [1] and hereby included by reference. In this process the gold containing solution is mixed with the graphene oxide solution and the sorption process occurred.

The enriched graphene oxide platelets then further extracted by the centrifugation, ultracentrifugation, filtration, ultra-filtration, precipitation, electrophoresis, reverse osmosis, sedimentation, incubation, treatment with acids, treatment with bases, treatment with chelating agents, and combinations thereof and then subjected to the process for further extraction of gold by meant of electrowinning, being exposed to a washing solution capable to detach the absorbed gold or by exposure to high temperatures in the presence of oxygen to remove the carbon content.

To facilitate the extraction of the enriched graphene oxide from the solution, the graphene oxide can be associated with a polymer to form a hydrogel composite. The polymers can be hyaluronic acid, chitosan, heparin, alginate, fibrin, polyvinyl alcohol, polyethylene glycol, sodium polyacrylate, polyethyleneimine, acrylate polymers and copolymers and combinations of thereof. Association of graphene oxide with such polymers.

One of the examples of the materials to be used as a sorption media for gold extraction is GO-chitosan composite. In the publication by Li Liu et al [2] the chitosan-GO (“CSGO”) composite with the content of GO to be 5%, 10% and 15%. was prepared and exposed to Pd(II) and Au (III) containing solution at various pH and then the concentration of the leftover metals was measured. The adsorption capacity of the 5% CSGO was measured to be 1,077 mg/kg.

In the other example presented in the publication by Kaige Sun et al [3] graphene oxide/magnetite/ascorbic acid hydrogel (rGO/Fe3O4/AAH) fabricated through one-step hydrothermal method was used to extract gold from the Au(CN)2- solution showing the absorption capacity of 309 mg/g. The enriched hydrogel can be easily extracted by a magnetic separator.

In another example presented in the publication by Lang Yang et al [4] the graphene oxide-polyethyleneimine hydrogel (GO/PEI hydrogel) was used to extract gold from the Au(CN)2- solution exhibiting the absorption capacity at the temperatures at 25 C and 35 C of 252.89 mg/g and 299.41 mg/g respectively.

Alternative to formation of hydrogels a water insoluble material allowing exposure of the gold or other metals containing solution could be an association of graphene oxide with activated carbon in a process described in a patent by D. Stolyarov et al [5] that can be followed by subsequent reduction of the graphene oxide deposited to the activated carbon by means of reduction with a chemical reduction agent such as hydrazine or other or by annealing at elevated temperature in the presence of oxygen.

### Fabrication of Articles from the Sorption Media

To be used for the extraction of gold and other methods in an industrial setting the sorption media should be converted to an article or set of articles and then packaged in a form of a filter and loaded into an apparatus that allows the metal containing solution to pass over and being exposed to the sorption media for efficient absorption.

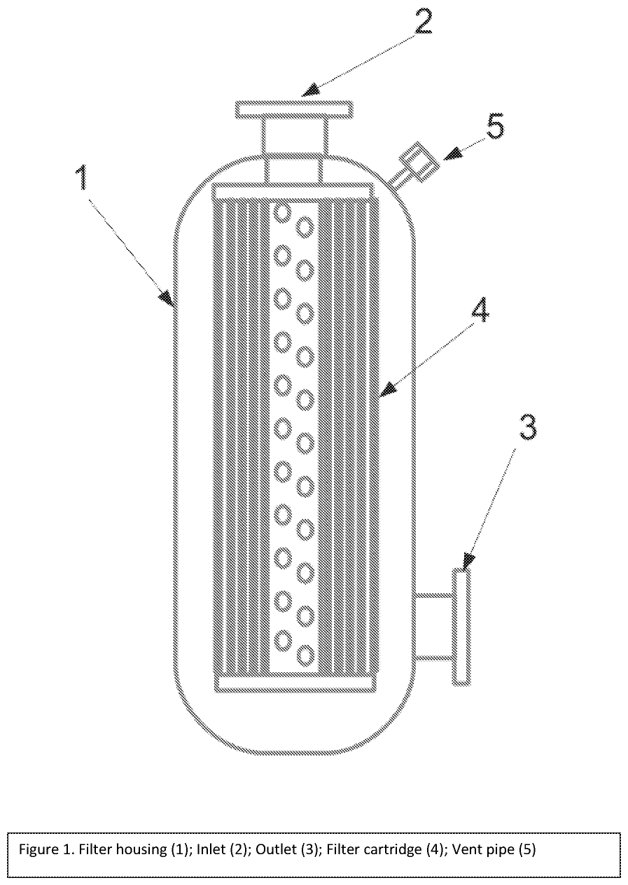

As illustrated in FIG. 1, such apparatus should consist of the filter housing, provisions to supply and remove the metal containing solution and the sorption media filter made out of the sorption media articles and constructed as a cartridge allowing convenient replacement and removal for the purpose of further metal extraction process and also containing a pump for conveying the metal containing solution in and out of the filter housing.

In one of the embodiments of the present invention such article is a set of pellets formed out of GO composite such as GO-hydrogel. Such articles can be formed by extrusion or coagulation, compression, or other suitable process.

The pellets can also be made out of GO impregnated activated carbon according to the reference by D. Stolyarov at al [5].

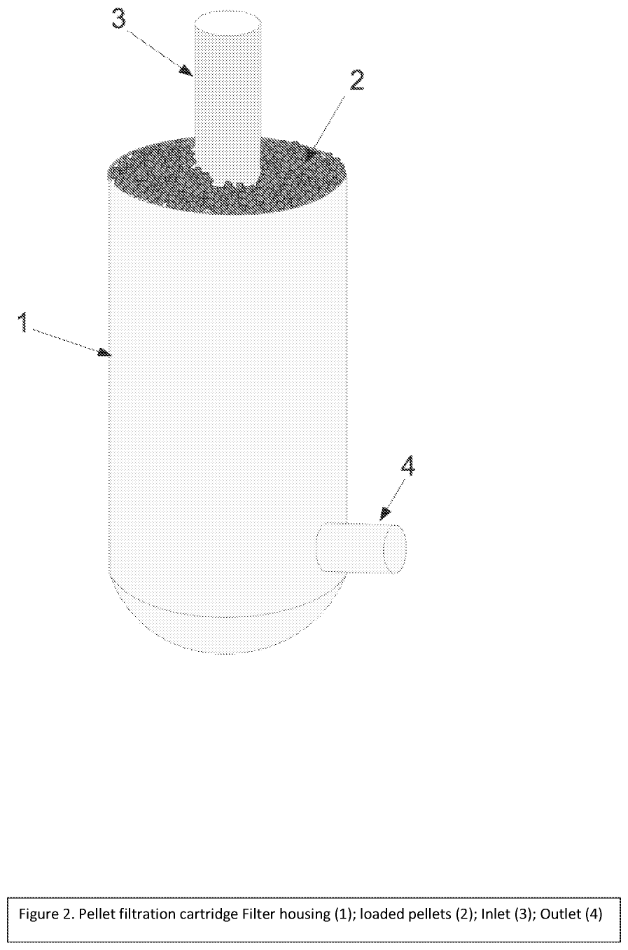

As perhaps best illustrated in FIG. 2, the pellets can be loaded into a vessel thereby forming a filter cartridge.

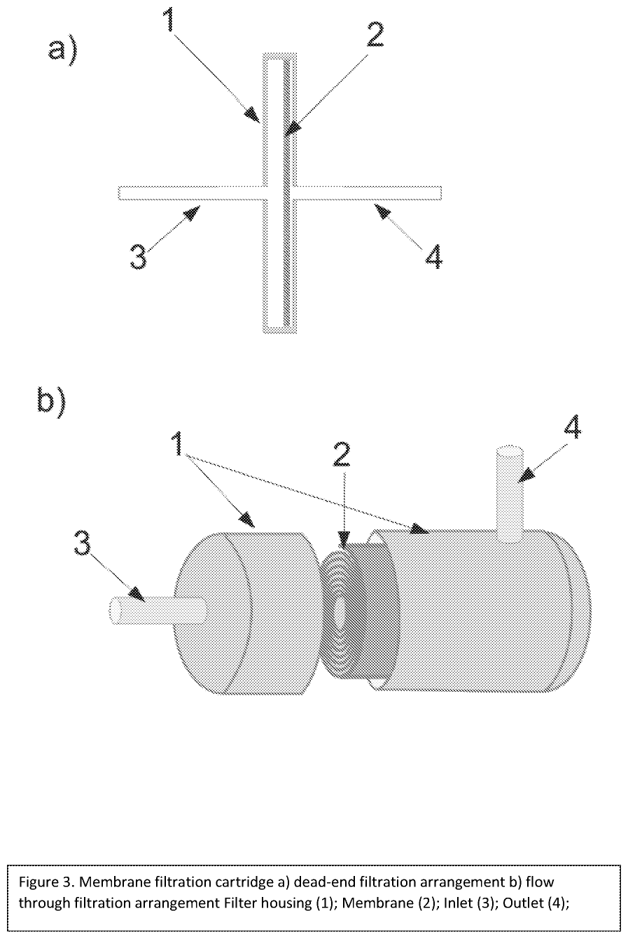

As perhaps best illustrated in FIG. 3, in the other embodiment of the present invention the sorption media article can be a membrane. Membrane is then loaded in a filter cartage in a dead-end filtration or pass over arrangement.

One of the examples of fabrication of the membranes out of chitosan—GO hydrogel is described in the US patent by V. Medina et al [6] where the chitosan graphene oxide solution is evaporated in a mold thereby forming a film of a desired thickness.

In the other embodiment of the present invention the article can be a fiber formed out of GO composite by the process of wet spinning, dry spinning, electrospinning or other suitable method.

The fibers can be formed out of GO solution by a wet spinning and coagulation process as described in the publication by Rouhollah Jalili et al [7] which then could be followed by chemical processing and/or reduction by annealing or with a suitable chemical agent such as hydrazine.

The fibers then can be formed to a yarn and winded over a spool thereby forming a filtration cartridge.

In the other embodiment of the present invention a textile is made from sorption media fiber and used for fabrication of the filtration cartridge.

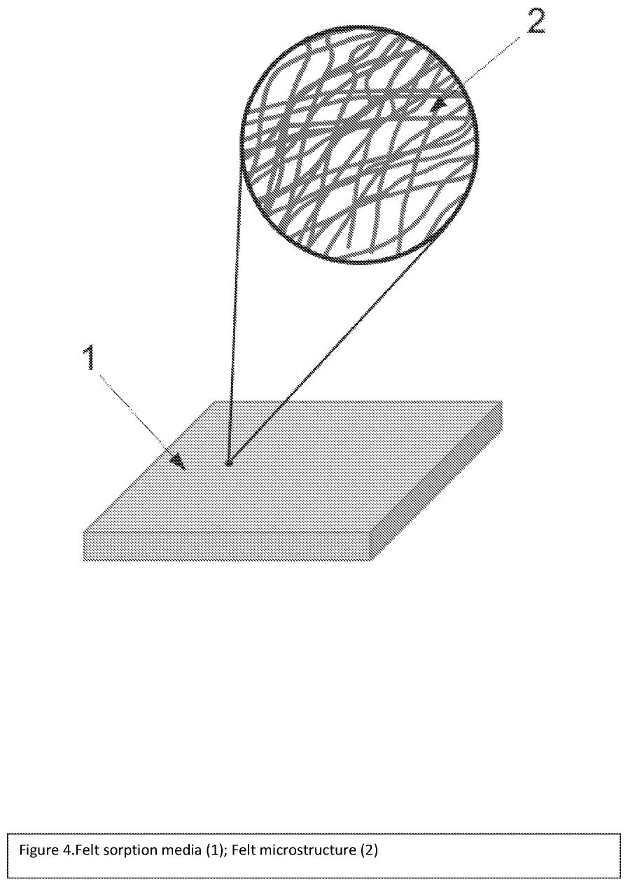

As also illustrated in FIG. 4, in the other embodiment of the present invention a felt is made from sorption media fiber and used for fabrication of the filtration cartridge.

Various aspects of present invention relate to sorption and extraction of different materials and metals including precious metals such as gold, platinum, rare earth metals, radioactive materials such as uranium and combination of thereof. Such methods generally include preparation of materials including graphene oxide in association of polymers such as hyaluronic acid, chitosan, heparin, alginate, fibrin, polyvinyl alcohol, polyethylene glycol, sodium polyacrylate, acrylate polymers and copolymers and combinations of thereof, graphene oxide in combination with activated carbon, zeolites, aluminosilicates, natural or synthetic clays as well as natural or synthetic fibers or synthetic fibers. Other methods include fabrication of the articles from the abovementioned materials including pellets, fibers, threads, yarns membranes. As well as methods for passing the liquid media containing the metals and materials for the purpose of sorption over the above-mentioned articles.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. A system for extraction of metal out from a liquid solution, the system comprising:
a housing having an inlet and an outlet; and
a filter carried by the housing, the filter comprising a sorption media that includes a graphene oxide material;
wherein the filter is in fluid communication with the inlet and with the outlet of the housing;
wherein the liquid solution is a liquid solution that contains at least one metal;
wherein the housing is shaped as a cartridge; and
wherein the inlet is configured to be removably engaged in fluid communication with an external apparatus that provides a source of the liquid solution.

2. The system of claim 1, wherein the graphene oxide material comprises at least one of graphene oxide, functionalized graphene oxide, reduced graphene oxide, and activated carbon impregnated with graphene oxide or with reduced graphene oxide.

3. The system of claim 1, wherein the graphene oxide material is a water insoluble hydrogel that comprises graphene oxide associated with at least one polymer.

4. The system of claim 3, wherein the at least one polymer comprises at least one of hyaluronic acid, chitosan, heparin, alginate, fibrin, polyvinyl alcohol, polyethylene glycol, sodium polyacrylate, and acrylate polymer/copolymer.

5. The system of claim 1, wherein the graphene oxide material is in combination with at least one of activated carbon, zeolite, aluminosilicate, natural clay, synthetic clay, natural fiber, and synthetic fiber.

6. The system of claim 1, wherein the filter comprises at least one of a membrane, fiber, felt, and a plurality of pellets.

7. The system of claim 1, further comprising a vent pipe in fluid communication with the housing.

8. The system of claim 1, wherein the filter is arranged to be in at least one of a dead-end filter arrangement and a pass-over filter arrangement.

9. The system of claim 1, wherein the at least one metal contained by the liquid solution comprises at least one of metal alloy, metal ingot, metal ore, metal ion, cationic metal ion, metal salts, chemical complex of metal, gold, platinum, rare earth metal, and radioactive metal.

10. A method for extraction of metal out from a liquid solution using a system that includes a housing that has an inlet and an outlet, the system further including a filter carried by the housing and comprising a sorption media that includes a graphene oxide material, wherein the filter is in fluid communication with the inlet and with the outlet of the housing, wherein the liquid solution is a contains at least one metal, and wherein the housing is shaped as a cartridge, the method comprising:
connecting the inlet to be in communication with a source of the liquid solution;
pumping the liquid solution into the inlet;
adsorbing the at least one metal of the liquid solution with the sorption media to define metal enriched sorption media; and
extracting the metal from the metal enriched sorption media.

11. The method of claim 10, wherein the step of extracting the metal from the metal enriched sorption media comprises at least one of centrifugation, ultracentrifugation, filtration, ultra-filtration, precipitation, electrophoresis, reverse osmosis, sedimentation, incubation, treatment with acids, treatment with bases, treatment with chelating agents, and magnetic separation.

12. The method of claim 10, further comprising disconnecting the inlet from the source of the liquid solution.

13. The method of claim 10, further comprising replacing the metal enriched sorption media with an unenriched sorption media.

14. The method of claim 10, wherein the graphene oxide material comprises at least one of graphene oxide, functionalized graphene oxide, reduced graphene oxide, and activated carbon impregnated with graphene oxide or with reduced graphene oxide.

15. The method of claim 10, wherein the graphene oxide material is a water insoluble hydrogel that comprises graphene oxide associated with at least one polymer.

16. The method of claim 15, wherein the at least one polymer comprises at least one of hyaluronic acid, chitosan, heparin, alginate, fibrin, polyvinyl alcohol, polyethylene glycol, sodium polyacrylate, and acrylate polymer/copolymer.

17. The method of claim 10, wherein the graphene oxide material is in combination with at least one of activated carbon, zeolite, aluminosilicate, natural clay, synthetic clay, natural fiber, and synthetic fiber.

18. The method of claim 10, wherein the filter comprises at least one of a membrane, fiber, felt, and a plurality of pellets.

19. The method of claim 10, wherein the filter is arranged to be in at least one of a dead-end filter arrangement and a pass-over filter arrangement.

20. The method of claim 10, wherein the at least one metal contained by the liquid solution comprises at least one of metal alloy, metal ingot, metal ore, metal ion, cationic metal ion, metal salts, chemical complex of metal, gold, platinum, rare earth metal, and radioactive metal.
